(19) United States
(12) Patent Application Publication
(10) Pub. No.: US 2008/0203233 A1
(43) Pub. Date: Aug. 28, 2008

(54) Flueted aircraft wing

(76) Inventor: Willard H. Schmidt, Albuquerque, NM (US)

Correspondence Address: Willard H. Schmidt, 2015 Altez NE, Albuquerque, NM, 87112, US

(21) Appl. No.: 11/709,674

(22) Filed: Feb. 23, 2007

(51) Int. Cl. B64C 23/00

(52) U.S. Cl. 244/199.1

(57) ABSTRACT

The flueted aircraft wing has one or more thin Streamline Flow Panels placed longitudinally over the upper surface of an aircraft wing, and extend out in front of the wing leading edge. These panels capture airflow from along the wing leading edge in addition to the relative wind flow ahead of the wing, and direct the total airflow over the surface of the wing. The Streamline Flow Panels partition regions of vortex airflow over the wing and reduce transverse airflow. Wing tip vortices and induced drag are greatly reduced, and lift is increased. Fuel economy is substantially improved because airflow energy losses are reduced.

### BACKGROUND

### DESCRIPTION OF PRIOR ART

The airfoil and wing design of the glider built and flown by Wilbur and Orville Wright in 1901 was based on aerodynamic data published by Otto Lilienthal and by Samuel Langley. The Wright brothers first powered airplane flight in 1902 was the result of experiments and an understanding of the basic concepts of aircraft wing design, with emphasis on a cambered wing and airflow. By the end of World War II, the era of supersonic aircraft flight and space rockets had arrived. The fundamentals of aerodynamic engineering had been well established. Aircraft wing and airfoil designs became more sophisticated and advanced at a rapid pace with the aid of high-speed computers.

### DRAWING FIGURES

FIG. 1 is a frontal isometric view that illustrates the flueted wing of an aircraft.

FIG. 2 is a top view of an aircraft with flueted wings.

FIG. 3 presents an isometric view of a Streamline Flow Panel that is to be mounted on the front and top surface of an aircraft wing.

### REFERENCE NUMERALS IN FIGURES

1. Aircraft fuselage
2. Aircraft wing
3. Streamline Flow Panel

### DESCRIPTION OF INVENTION

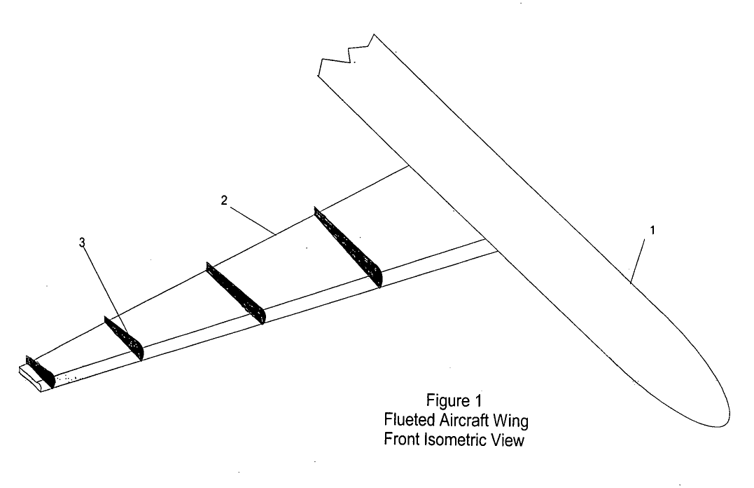

The modem aircraft of today has a fuselage 1 with a wing 2 on each side to provide vertical lift for the aircraft by virtue of the relative wind resulting from the speed of the aircraft. See FIG. 1.

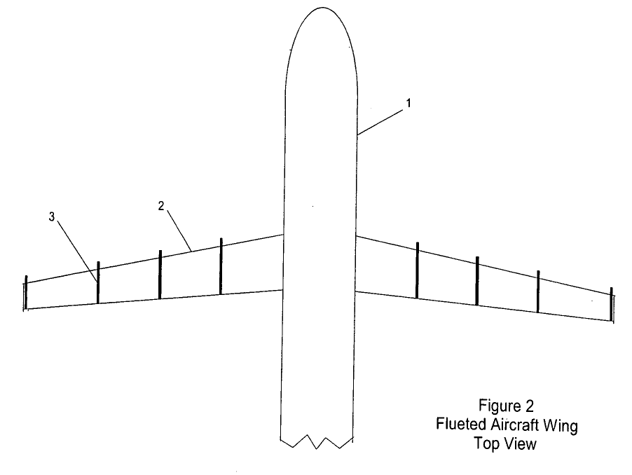

As shown in FIG. 2, the flueted wing 2 of this invention consists of one or more Streamline Flow Panels 3 mounted in the longitudinal direction on the front and top surface of the aircraft wing 2. These panels 3 are spaced apart to provide maximum streamline airflow over the surface of the wing 2.

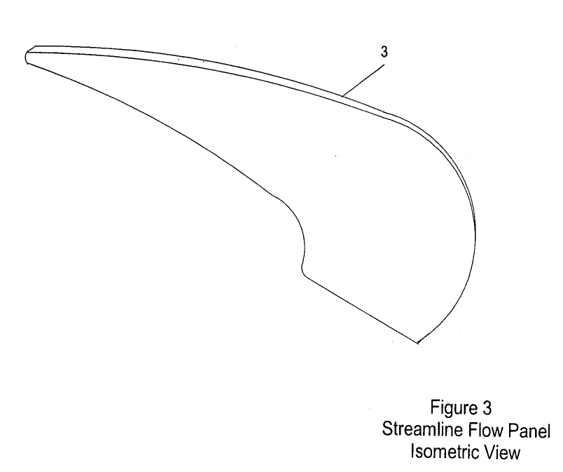

The Streamline Flow Panel 3 shown in FIG. 3 is contoured to fit over the leading edge of the wing 2 and lay over the cambered top surface of the wing 2.

### OPERATION OF INVENTION

Streamline Panels 3 extend over the leading edge, and along the top surface of the aircraft wing 2, to capture the relative wind flow ahead of the wing 2 and direct streamline airflow over the cambered surface of the wing 2. See FIGS. 1 and 2.

Airflow along the leading edge of the wing 2 is captured by the Streamline Panels 3, shown in FIG. 3, and forced over the wing 2 surface. This combined total airflow increases in velocity as it is directed over the cambered wing 2 surface and results in a pressure decrease in accordance with Bernoulli's Theorem or Equation. The reduced pressure provides a lifting force for the aircraft. This is in accordance with the Kutta-Joukowski theorem which states that lift is proportional to airflow circulation around the wing.

As shown in FIGS. 1 and 2, the Streamline Panels 3 located in the longitudinal direction over the surface of the aircraft wing 2 reduce translation airflow across the wing 2 and thereby reduce shear stress in the airflow. The Streamline Panels 3, illustrated in FIG. 3, function to partition regions of vortex airflow over the wing 2. The panels 3 increase vortices in the streamline airflow over the wing 2 and increase wing efficiency. Lift is increased and drag is decreased. The Streamline Panels 3 essentially eliminate both wing tip vortices and induced drag. The Kutta Condition for smooth airflow over the trailing edge of the wing 2 is satisfied by the directed streamline airflow provided by the Streamline Panels 3 on the wing 2. The trailing airflow vortices are reduced by these panels 3, and, consequently, energy loss is reduced.

### CONCLUSIONS AND SCOPE OF INVENTION

The flueted aircraft wing 2, shown in FIG. 1, is an aircraft wing fitted with Streamline Panels 3 to capture the freestream air velocity and direct it over the leading edge of the wing 2 and onto the cambered upper surface of the wing 2. Airflow along the leading edge of the wing 2, that would otherwise be lost, is now directed over the upper surface of the wing 2 to provide lift. The Streamline Panels 3, shown in FIG. 3, act to partition regions of vortex airflow, as shown in FIG. 2, and reduce the translation velocity of air across the wing 2 to eliminate wing tip vortices that consume energy and increase drag. The flueted wing 2 is a more efficient wing that makes for a much safer aircraft with increased lift, reduced drag, and reduced stalling speed. The aircraft fuel economy is greatly enhanced by the flueted wing 3 because airflow is more streamlined and energy is not lost by wing tip vortices and induced drag.

I claim:

1. A fleuted aircraft wing.

2. The wing of claim 1 on which are mounted one or more Streamline Flow Panels.

3. The Streamline Control Panels of claim 2 located on the leading edge and over the top surface of the wing in claim 1.

4. The Streamline Control Panels of claim 2 placed on the wing of claim 1 in a longitudinal direction.

5. The Streamline Control Panels of claim 2 spaced apart to maximize capture of relative wind flow ahead of the wing in claim 1 to enhance airflow over the wing in claim 1.

6. The Streamline Control Panels of claim 2 to partition regions of vortex airflow over the wing in claim 1 to provide greater lift and streamline air flow.

7. The Streamline Control Panels of claim 2 to capture airflow along the leading edge of wing in claim 1 and direct the increased airflow over the top surface of wing in claim 1.

8. The Streamline Control Panels of claim 2 to reduce transverse airflow across the wing in claim 1 in order to minimize shear stress in the airflow stream.

9. The Streamline Control Panels of claim 2 to reduce wing tip vortices and reduce induced drag on the airplane.

10. The Streamline Control Panels of claim 2 to streamline the airflow over the surface of the wing in claim 1 to increase lift and reduce drag.

11. The Streamline Control Panels of claim 2 to enhance aircraft fuel economy by reducing airflow energy losses.

12. A Streamline Control Panel of thin cross section made to fit the contour of the leading edge and top surface of the wing in claim 1 while extending out in front of the leading edge of the wing in claim 1 and along the top surface of the wing in claim 1.
